(19) United States
(12) Patent Application Publication
(10) Pub. No.: US 2007/0150223 A1
(43) Pub. Date: Jun. 28, 2007

(54) Method for verifying compliance with a performance specifications assigned to a medical working practice

(76) Inventors: Klaus Abraham-Fuchs, Erlangen (DE); Eva Rumpel, Erlangen (DE); Markus Schmidt, Nurnberg (DE); Siegfried Schneider, Erlangen (DE); Horst Schreiner, Furth (DE); Gudrun Zahlmann, Neumarkt (DE)

Correspondence Address: HARNESS, DICKEY & PIERCE, P.L.C., P.O.BOX 8910, RESTON, VA, 20195, US

(21) Appl. No.: 10/589,538

(22) PCT Filed: Feb. 9, 2005
(86) PCT No.: PCT/EP05/50554

§ 371 Date: Aug. 16, 2006

(30) Foreign Application Priority Data
Feb. 18, 2004 (DE) 10 2004 008 195.6
Oct. 28, 2004 (DE) 10 2004 052 536.6

(51) Int. Cl. G06F 19/00

(52) U.S. Cl. 702/108

(57) ABSTRACT

A method is disclosed for verifying whether an implementation rule assigned to a medical procedure has been observed. The method includes: data correlated with the procedure is automatically entered and stored in a data processing device; test criteria for the data, which are correlated with the implementation rule, are stored in a test system; the procedure is implemented; the test system reads out the data from the data processing device; and the test system evaluates the data based on the test criteria and determines to what degree the implementation rule has been observed.

### PRIORITY STATEMENT

This application is the national phase under 35 U.S.C. §371 of PCT International Application No. PCT/EP2005/050554 which has an International filing date of Feb. 9, 2005, which designated the United States of America and which claims priority on German Patent Application numbers DE 10 2004 008 195.6 filed Feb. 18, 2004 and DE 10 2004 052 536.6 filed Oct. 28, 2004, the entire contents of which are hereby incorporated herein by reference.

### FIELD

The invention generally relates to a method for verifying compliance with a performance specification assigned to a medical working practice.

### BACKGROUND

Many medical working practices are subject to performance specifications. For clinical studies, there are study protocols which contain instructions worked out to the last detail, so-called SOPs (standard operating procedures). In this way, for example, the inclusion and exclusion criteria for the recruitment of patients as participants in the clinical study are set very accurately. For medical research projects, for example in the scope of a dissertation, there are extremely complex rules for the performance of particular working practices. For everyday working practices in a clinic organization, there are more or less detailed medical guidelines for diagnoses, therapies or routine treatments. The performance specifications may in this case equally well apply for patients, doctors or other medical staff.

Medical routine is distinguished by a number of media breaches in working practices. Data are transferred from one medium to the next in such a media breach, for example by a printout or memo and entered into a form, committed to memory and subsequently noted or read from a display and typed into a data terminal.

Although security measures are provided for many media breaches, for example independent double data entry by data typists who enter data from a form into a data-processing system, there are nevertheless potential sources of error for the data to be transferred wherever there is a media breach. Furthermore, many media breaches offer simple opportunities for the active manipulation of data. Owing to financial interests, for example, patients known to be unsuitable for a clinical study may be recruited in a clinic if such patients are difficult to find, since the clinic receives a particular remuneration per study participant recruited. Patients unsuitable for a clinical study on humanitarian grounds, for example who cannot pay for a therapy which they obtain free of charge in the scope of a clinical study, or who are administered an active agent promising hope in the event of a short life expectancy, are also selected.

In order to limit the workload, for example, only a few data are often transferred from one medium to the next in the event of media breaches. Accompanying information which was also obtained when gathering the data in the first medium, and which supports the reliability of the data, becomes lost. During the electronic recording of an X-ray image according to the DICOM standard, for example, much additional information such as exposure time, accelerating voltage, time and date of the recording, frequency of the radiation, is also stored with the image. When the image is printed out on paper, this information is not printed out as well, and it becomes lost. Retrospective access to such data is possible only with difficulty, or is impossible. During a subsequent comparison, only images of different patients which were recorded with the same accelerating voltage should be compared. This information, however, is irretrievably lost on the images printed out. The comparison cannot be carried out reliably.

The compliance with performance specifications for medical working practices is nowadays confirmed merely through signature by the persons responsible. If the working practice is a measurement, at the end of it only the measurement value besides the signature is usually available in order to verify that it was actually carried out, and in a pure therapy measure no further information is available at all. Retrospective verification of compliance with the performance specification for the medical working practice is thus limited to checking the signature.

### SUMMARY

At least one embodiment of the present invention includes improving the verification of a working practice subject to a performance specification.

A method is disclosed for, in at least one embodiment, verifying compliance with a performance specification, the performance specification being assigned to a medical working practice. The method has the following steps: data correlated with the working practice are automatically recorded and stored in a data-processing device. Test criteria for these data are stored in a test system, the test criteria being correlated with the performance specification. The working practice is carried out. The test system reads the data out from the data-processing device. The test system evaluates the data with the aid of the test criteria, and determines the degree of compliance with the performance specification.

A medical working practice is, for example, the recruitment of patients in a clinical study, the recording of a measurement value from a patient (blood pressure, pulse) or in a laboratory (blood values with the aid of a blood sample), an examination, treatment or therapy carried out on a patient, the taking or giving of a medicament by a patient or doctor, the conduct of particular actions by a patient such as sporting activity, compliance with a rest phase and adopting a particular physical posture (sitting, lying).

The performance specifications assigned to the working practices are specifications or instructions in the scope of a research project, SOPs of clinical studies or guidelines for medical procedures or treatments, standard process steps or measurement specifications; Inclusion and exclusion criteria for a clinical study, instructions to a patient or doctor, particular times or durations for physical activities or examination methods to be complied with.

As data which are correlated with the working practice and are automatically recorded, processed or stored in a data-processing device, only a few will be mentioned here by way of example: personal details, history of illness and hospitalization times, which are stored in a clinic information system, a patient file, health card or the like, characterize a patient and can thus be correlated with inclusion and exclusion criteria of a clinical study. Entries in electronic calendars, signing into clinic management systems or log files in laboratory equipment give information about times or durations of hospital stays, doctors, visits, the use of particular devices or equipment, for example an exercise bicycle or a laboratory station. Data stored in laboratory equipment about calibration times, calibrating solutions (recorded in the equipment by barcode readers), operating times and parameters, environmental variables (room temperature, relative humidity) of a device, recording parameters of an X-ray image etc. give information about boundary conditions or other circumstances under which measurement values, images or other data are collected. The more such data are available, the more accurately the performance specifications can be verified, since commensurately more information can be evaluated making it possible to verify compliance with the various details of an instruction when actually carrying out a working practice.

These data are recorded automatically, in so far as they are simply created when carrying out the working practice without special action. For instance, a patient is always signed into a clinic information system when they enter the door, log files in equipment are constantly updated as soon as the equipment is connected to the power supply. The appointment entries of patients' visits to a doctor are necessarily made in a practice management system in the scope of billing for the medical services.

All verifiable relationships between performance specifications and stored data are conceivable as test criteria. For example, it is possible to verify prescribed times or durations through times recorded in log files, such as attendance times of staff or doctors. Both test criteria which confirm compliance with a specification (patient had an appointment with a doctor) as well as those which disprove compliance (doctor was not actually at the clinic on the day in question) are conceivable. If a follow-up examination by a doctor is prescribed 7 days after giving a medicament, for example, then the appointment entry in their practice management system may be used as a test criterion. The corresponding test criteria are established in the individual case, for example by an expert committee.

The data are read out from the corresponding data-processing devices and sent to the test system. Here, it is not important whether the test system and the data-processing device are located at one place or are correspondingly remote from each other. For example, the test system may be located at the sponsor or backer of a clinical study and have access to all devices in test centers, for example distributed Europe-wide, in order to collect their data.

Since the test system reads out and correspondingly further processes or forwards the data, media breaches no longer take place here. For example, measurement values are thus directly transferred from the measurement device into the study database. This avoids the transfer errors in media breaches for such a measurement value. In contrast to merely checking the signature, the additional evaluation of the correlated data provides an objective, transparent and reproducible possibility of verification, to validate actual compliance with the test criteria in each individual case. By evaluating additional information correlated with a measurement value, for example, after determining the measurement values it is possible to calculate correction factors which take into account modified measurement conditions for different measurement values, and thus make the measurement values comparable.

The data which have been read out can now be evaluated by suitable data-processing methods and checked for compliance with the test criteria.

Here, it is possible to determine a degree of compliance with the specifications, for example in per cent, which confirms how well the specifications were complied with. This allows further evaluation of results of the medical working practice. For example, medical working practices in which the specifications were complied with by more than 75% are employed for comparison, and other working practices are not included. A comparison thus delivers values that are more objective than when all the working practices are compared.

The degree of compliance may also express which sub-specifications were followed and which were not. It is thus retrospectively possible to decide whether, for example, not following a sub-specification is inconsequential for a comparison with other working practices. The degree of compliance may moreover lead to a simple Yes/No decision, i.e. compliance or noncompliance with the performance specification.

In contrast to merely checking the confirmation signature, at least one embodiment of the method allows automatic and much more thorough working practice validation, i.e. taking substantially more information into account, and a multiplicity of accompanying parameters may be employed for the validation. The validation, which is thus more objective, significantly increases the comparability of medical working practices even when they have been carried out under different conditions at different places.

The deliberate manipulation of working practices is restricted since there are objective control data, all of which would also have to be manipulated. Data collected by measurement are thus more secure against falsification. Performance specifications can no longer be forgotten once they have been stored in the form of a test criterion in the test system, since they are automatically verified with all other criteria. The quality of the medical working practice, and that of data possibly collected by it, is significantly increased overall. The test method may be carried out automatically or manually after each working practice, or periodically activated from time to time independently of the working practice.

If clinical data are collected as the medical working practice, the collection process being assigned a collection protocol as the performance specification, then compliance with the performance specifications can be checked with arbitrary accuracy depending on the outlay or complexity and number of the test criteria, or data correlated with the working practice. Tracking of the performance specifications, which can be guaranteed with an arbitrary accuracy for example, significantly reduces the statistical spread of collected data so that substantially less data need to be collected in order to achieve the same data quality. Since the data quality of the collected clinical data is therefore significantly improved, for example in a clinical study, the same result quality can be achieved with reduced outlay.

A measurement value for a clinical study may be collected from a patient as the medical working practice and, if the collection protocol is complied with, the test system may send the measurement value as a valid measurement value to a study database. This ensures that only measurements, and therefore measurement values, satisfying the performance specifications in the scope of the test criteria are declared valid and enter the study database. The quality of a clinical study depends critically on the data quality in the study database. The present method significantly increases this, which leads to a reduction of the participant number and therefore to a significant cost saving and time advantage when carrying out the clinical study.

A knowledge-based system may be used as the test system, the performance specifications being stored in the form of a rule set in the knowledge-based system. A knowledge-based system is, for example, an expert system. Knowledge-based systems are readily extendable: for instance, new test criteria can easily be assigned to the performance specifications and incorporated into an existing system, for example when the verification of a particular performance specification is insufficient, without having to interrupt the continuing operation of the system or readapt all previously stored rules.

If the performance specifications are stored as modules in the rule set, for example, then the modules may be assigned to different classes such as modules which are assigned to ever-recurring working practices, for instance study-specific modules, modules which are standardized for particular measurement routines and can be used in different working practices. Other modules fundamentally describe basic rules of particular working practices, and are employed in a multiplicity of working practices.

Such modular systems are readily extendable; it is possible to resort to modules already proven in previous working practices and known to be error-free, and a module for a particular working practice needs to be compiled only once and not repeatedly every time.

The method may be carried out automatically after each medical working practice. This ensures that each working practice is actually verified, which significantly increases the verification of compliance with the performance specifications, for example in contrast to spot checks. The verification does not have to be explicitly requested every time, and therefore cannot be forgotten.

If the performance specification is not complied with, a decision may be made as to whether it is possible to repeat the working practice. If repetition is possible, then a repetition request may be sent to those carrying out the working practice. If a performance specification is infringed, a direct or prompt message may be sent in order either to repeat the working practice or to give those carrying it out indications of specification infringements. Systematic errors can thus be detected and corrected early on so that, for example, the next working practice of the same type can already be carried out correctly i.e. according to the performance specifications.

### BRIEF DESCRIPTION OF THE DRAWINGS

For a further description of the invention, reference will be made to the example embodiments of the drawings in which, in a schematic representation:

FIG. 1 shows a flow chart for the performance and verification of a medical working practice.

### DETAILED DESCRIPTION OF THE EXAMPLE EMBODIMENTS

In the example, a pH measurement 2 taken from a patient is carried out as the medical working practice in the scope of a clinical study on a blood sample (not shown).

To this end, a pH meter 4 is used. The pH meter 4 is processor-controlled and has a data memory, in which a log file 8 is made. The log file 8 is generated by the pH meter 4, and manages and contains various entries: equipment type/date, time and result i.e. pH value 6 of the pH measurement 2/date and time of the equipment calibration and type of the calibrating solution.

The following SOPs are set as performance specifications for determining the pH value 6 in the study protocol of the clinical study:
The pH measurement 2 with the pH meter 4 delivers a valid pH value 6 only when it is calibrated according to specification.
Calibration according to specification means that the pH meter 4 has been calibrated not more than one week before the pH measurement 2 with the calibrating solution approved for the equipment type of the pH meter 4.
Calibrating solution “B” is approved for the equipment type “A” of the pH meter 4.

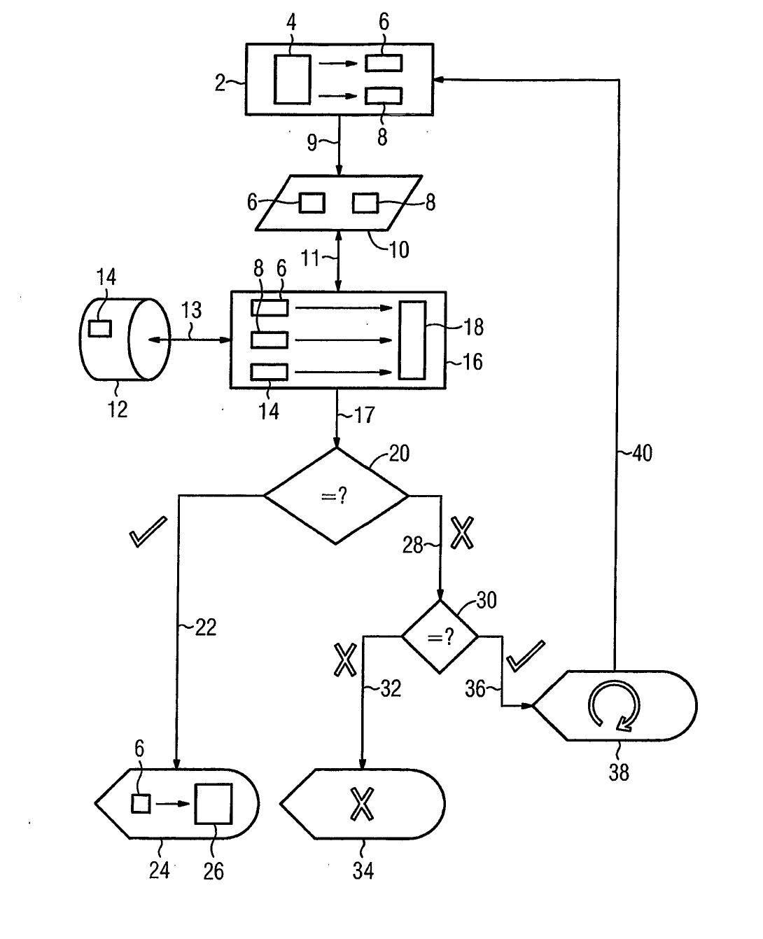

FIG. 1 schematically shows the procedure for carrying out and verifying the pH measurement 2. The pH measurement 2 is first carried out by a laboratory worker (not shown) in a medical laboratory. As a result 10 of the pH measurement 2, after it is concluded, the pH value 6 and the log file 8 are present in an electronic form in the pH meter 4, as indicated by the arrow 9 in FIG. 1. The information of the log file 8 is therefore data correlated with the pH measurement 2.

The SOPs of the clinical study were converted into test criteria 14 by an expert team before the beginning of the study and stored in an electronic form in the database 12. In the present example, the test criteria read:
time of determining the pH value 6 is the value stored in the log file.
The last calibration date noted in the log file 8 must be at most one week before the time of determining the pH value 6.
The approved calibrating solution type “B” is to be used for the type “A” pH meter 4.

The log file 8, the pH value 6 and the test criteria 14 are sent to a test system 18, as represented by the arrows 11 and 13. From the log file 8, the date and time of the pH measurement 2 are compared by the test system 18 with the date and time of the last calibration. The data are evaluated with the aid of the test criteria 14 and compliance with the SOPs, i.e. the performance specifications, is thus determined. The comparison reveals that the calibration took place 52 hours before the measurement, i.e. less than one week. This test criterion 14 is fulfilled.

The test system 18 furthermore learns from the log file 8 that the pH meter 4 used for the measurement bears the type reference “A”. It is also noted in the log file 8 that the last calibration was carried out with the calibrating solution “B”. This is registered automatically by the pH meter 4, since a label applied to a bottle of calibrating solution is recognized with the aid of a barcode reader built into the pH meter. This test criterion 14 is thus likewise fulfilled.

The decision 20 following the test step 16 in the direction of the arrow 17 gives the Yes decision 22 owing to the compliance with the performance specifications 14, so that the pH value 6 is classified in the conclusion step 24 as a valid measurement value in the scope of the clinical study and taken into a study database 26. Since the test system 18 has an interface to a PC of the laboratory worker carrying out the measurement, immediately after completing the pH measurement 2 the laboratory worker receives the report that it has led to a valid pH value 6 and is therefore concluded properly.

If one of the test criteria 14 is not fulfilled in the comparison 20, for example because the calibration of the pH meter 4 took place nine days before the pH measurement 2, then the decision at 20 gives a No decision 28. The pH value 6 has thus not been determined according to specification and, according to the SOP, must not be included in the clinical study.

This leads to a repetition test 30, in which the test system 18 decides according to the SOPs whether the pH measurement 2 can be repeated in the specific case, in order to allow compliance with the test criteria 14 in another pH measurement 2 and thus still obtain a valid pH value 6.

The determination of the pH value 6 in the patient's blood cannot be repeated in the present case, since the blood sample is used up and a new blood sample can no longer be taken. This is because since then the patient has taken a medicament which affects the pH value of their blood.

The repetition test 30 therefore leads to a No decision 32. In the conclusion step 34, the measurement value 6 is discarded i.e. not taken into the study database 26. A message is furthermore sent to the laboratory worker, which requests them urgently to calibrate the pH meter 4 properly for the next measurement. The corresponding specification from the SOPs is displayed as a reminder.

If the repetition test 30 leads to a Yes decision 36, since there is still a blood sample of the patient on which another pH measurement 2 can be carried out, and it is thus compatible with the study protocol for the pH measurement 2 to be repeated, then a repetition step 38 takes place. Here, the current pH value 6 is discarded and a message is sent by the test system 18 to the laboratory worker. This requests the laboratory worker to calibrate the pH meter 4 according to specification and then carry out a new pH measurement 2. The method therefore returns along arrow 40 to the first step, i.e. carrying out the pH measurement 2 again, and the method sequence represented in FIG. 1 is automatically initiated once more.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for determining a degree of compliance with a performance specification assigned to a medical working practice, the method comprising:
recording and storing data correlated with the medical working practice in a data-processing device;
storing test criteria for the data, correlated with the performance specification, in a test system;
carrying out the working practice;
reading, via the test system, the data out from the data-processing device; and
evaluating, via the test system, the data with the aid of the test criteria and determining a degree of compliance with the performance specification.

2. The method as claimed in claim 1, wherein:
clinical data are collected as the medical working practice, the collection process being assigned a collection protocol as the performance specification.

3. The method as claimed in claim 2, wherein:
a measurement value for a clinical study is collected from a patient as the medical working practice, and
the test system sends the measurement value as a valid measurement value to a study database if the collection protocol is complied with.

4. The method as claimed in claim 1, wherein:
a knowledge-based system is used as the test system, and
the performance specification is stored in the form of a rule set in the knowledge-based system.

5. The method as claimed in claim 4, wherein the performance specification is stored as a module in the rule set.

6. The method as claimed in claim 1, wherein the method is carried out automatically after each medical working practice.

7. The method as claimed in claim 1, wherein:
if the performance specification is not complied with, a decision is made as to whether it is possible to repeat the working practice and, if so, repetition is requested; and
if repetition is possible, a corresponding repetition request is made to those carrying it out.

8. The method as claimed in claim 2, wherein:
a knowledge-based system is used as the test system, and
the performance specification is stored in the form of a rule set in the knowledge-based system.

9. The method as claimed in claim 3, wherein:
a knowledge-based system is used as the test system, and
the performance specification is stored in the form of a rule set in the knowledge-based system.

10. The method as claimed in claim 8, wherein the performance specification is stored as a module in the rule set.

11. The method as claimed in claim 9, wherein the performance specification is stored as a module in the rule set.

12. The method as claimed in claim 2, wherein the method is carried out automatically after each medical working practice.

13. The method as claimed in claim 3, wherein the method is carried out automatically after each medical working practice.

14. The method as claimed in claim 4, wherein the method is carried out automatically after each medical working practice.

15. The method as claimed in claim 5, wherein the method is carried out automatically after each medical working practice.

16. The method as claimed in claim 2, wherein:
if the performance specification is not complied with, a decision is made as to whether it is possible to repeat the working practice and, if so, repetition is requested; and
if repetition is possible, a corresponding repetition request is made to those carrying it out.

17. The method as claimed in claim 3, wherein:
if the performance specification is not complied with, a decision is made as to whether it is possible to repeat the working practice and, if so, repetition is requested; and
if repetition is possible, a corresponding repetition request is made to those carrying it out.

18. The method as claimed in claim 4, wherein:
if the performance specification is not complied with, a decision is made as to whether it is possible to repeat the working practice and, if so, repetition is requested; and
if repetition is possible, a corresponding repetition request is made to those carrying it out.

19. The method as claimed in claim 5, wherein:
if the performance specification is not complied with, a decision is made as to whether it is possible to repeat the working practice and, if so, repetition is requested; and
if repetition is possible, a corresponding repetition request is made to those carrying it out.

20. The method as claimed in claim 6, wherein:
if the performance specification is not complied with, a decision is made as to whether it is possible to repeat the working practice and, if so, repetition is requested; and
if repetition is possible, a corresponding repetition request is made to those carrying it out.
